(19) United States
(12) Patent Application Publication
(10) Pub. No.: US 2006/0203275 A1
(43) Pub. Date: Sep. 14, 2006

(54) Image forming apparatus and image forming method

(75) Inventor: Akihiro Moro, Shizuoka-Ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,314

(22) Filed: Oct. 31, 2005

(30) Foreign Application Priority Data
Mar. 14, 2005 (JP) 2005-071213

(51) Int. Cl. G06F 3/12

(52) U.S. Cl. 358/1.13

(57) ABSTRACT

An image forming apparatus includes a reading unit for reading a document and converting the document into image data, a document-type determining unit for distinguishing between a general document and a special document based on the image data, a read-processing unit for performing read processing on the general document and on the special document, an image-processing unit for performing image processing on the general document and on the special document, and a control unit. When the distinguished document is the special document, the control unit sets the read-processing unit to a special read-processing mode and sets the image-processing unit to a special image-processing mode. When the distinguished document is the general document, the control unit sets the read-processing unit to a normal read-processing mode and sets the image-processing unit to a normal image-processing mode.

### BACKGROUND OF THE INVENTION

1. Field of the Invention

The present invention relates to image forming apparatuses and image forming methods. In particular, the present invention relates to an image forming apparatus and an image forming method which input documents and/or images and store, print, or display them.

2. Description of the Related Art

Today, at companies and so on, in order to address the problems of information sharing and information storage places, digitizing documents printed on paper or the like and storing the resulting electronic documents as image data is becoming common.

Digitizing an enormous volume of print documents and storing the resulting electronic documents on, for example, a certain server in a company allows the information to be shared, so that a person who needs the information can easily access the electronic information whenever necessary. With respect to information that has already been digitized, hard copies thereof can be produced based on the electronic information, whenever necessary. Thus, there is no need to store the source print documents, thus contributing to a reduction in storage space.

However, not all documents are digitized in practice. For example, even today, the so-called “original documents” of tax/finance-related forms, finance-related documents, and so on (hereinafter referred to as “tax/finance-related documents”) are generally stored, at companies and so on, in the form of paper as the original documents without being digitized.

The reason is that, while there are restrictions in terms of a legal system, technology for reading one and only original document while allowing higher reproducibility therefor to be ensured than that for general documents and for printing the read electronic information with high reproducibility is not necessarily sufficient from a technical point of view.

More importantly, conventionally, for image forming apparatuses, such as scanners and so on, technology for ensuring data security, such as confidentiality and tamper protection, has not been sufficiently developed and thus has not put to practical use.

However, in recent years, technologies for higher resolution and higher color reproducibility for image forming apparatuses, such as scanners, are making considerable progress and security technologies for confidentiality improvement, tamper protection, and so on are also making great progress. Thus, from a technological point of view, digitizing the original documents of tax/finance-related documents or the like and storing and maintaining the resulting electronic documents as the electronic master copies can eliminate the need for continuously storing the source original documents in the form of paper.

In conjunction with the progress of those technologies, there is also a trend toward accepting digitized documents as the electronic master copies with respect to some tax/finance-related documents in the legal system as well.

On the other hand, with the advancement of network technologies, digitized documents are often transferred to remote places through networks. Thus, image forming apparatuses, such as scanners and copiers, that have conventionally been used in a stand-alone manner in many cases, are also equipped with various communication functions, image-file conversion functions associated therewith, and so on. Therefore, the trend toward functional diversification is remarkable.

In conjunction with the functional diversification, operations for image forming apparatuses and so on in recent years have become complicated. Thus, there is a demand for a technology for enabling simpler operations while achieving a variety of functions.

For example, JP-A 2001-285534 discloses a technology for an image forming apparatus that is capable of reducing the complexity involved in the diversification of communication.

Although digitizing documents, such as tax/finance-related documents, requires a technology for ensuring higher security and higher reproducibility than those for general documents, the technology may be incompatible with a technology for digitizing general documents.

For example, for digitizing tax/finance-related documents, there is a demand for a function for performing reading that allows for determination as to whether or not paper original documents before digitization have been tampered with using white-out or the like. Such a function can prevent electronic master copies from being generated based on tampered documents.

In many cases, the white color of the white-out or the like is whiter (i.e., is high in brightness) than the underlying white color (i.e., the paper color) of documents. Thus, the provision of a function for reading even the high-brightness white color of the white-out or the like makes it possible to prevent electronic master copies from being generated based on tampered documents.

In contrast, for reading and digitizing general documents, a function for reading the documents such that the underling white color (i.e., paper color) of the documents does not stand out is provided to prevent the underlying white color from looking like stains.

More specifically, for example, appropriately setting a tone characteristic of a scanner provides such a saturation characteristic that white color that is brighter than the underlying white color of a document does not exceed the brightness of the underling white color of the document. Further, during printing, the arrangement is such that the underlying white color of the document has substantially the same brightness as the white color of print paper. This processing (hereinafter referred to as “normal underlying-color processing”) prevents the underlying white color of the document from appearing on a print document, thus making it possible to create a clear print document.

Since color that is brighter than the underlying color of a document is saturated in the “normal underlying-color processing”, information regarding the high-brightness white color of the white-out or the like is lost in the reading process and thus the white color cannot be read.

Accordingly, in order to read the high-brightness color of the white-out or the like, the tone characteristic of the scanner needs to be a tone characteristic that is not saturated even at higher brightness than the underlying white color. That is, there is a need to provide “dedicated underlying-color processing”, which is different from the “normal underlying-color processing”, and to select one of them.

The necessity of varying the scanner processing for a case in which a general document is read and a case in which a special document, such as a tax/finance-related document, is read has been described in the example of the above underlying-color processing.

Even for a case other than the underlying-color processing, the provision of different processing functions between a mode for reading a general document (this mode will hereinafter be referred to as a “normal mode”) and between a mode for reading a special document, such as a tax/finance-related document, (this mode will hereinafter be referred to as a “special mode”) and appropriately selecting a processing function for the normal mode or the special mode can provide superior advantages.

For example, for special documents, such as tax/finance-related documents, the significance of character information is high compared to general documents containing pictures or the like and the necessity of accurately reading even small characters is also high. Thus, in the special mode, processing that enhances characters is required compared to the normal mode and an image processing filter for enhancing characters is selected.

Furthermore, in order to digitize a special document, such as a tax/finance-related document and approving it as an electronic master copy, for a example, a certification or time stamp (information of year/month/date/time at the time of digitization) issued by a third party may be embedded as special electronic information. In such a case, the read special document may be stored in a file format that is different in a file format used in the normal mode or may be transferred to an external apparatus via an interface that is different from an interface used in the normal mode.

In such an image forming apparatus having the normal mode and the special mode, processing functions and the number of types of processing are increased and thus complexity is also increased.

Consequently, if the selection of the individual processing functions and the setting of parameters during the setting between the normal mode and the special mode are left to a user, the operational burden on the user is considerably increased. The risk of operation mistake is also increased.

### SUMMARY OF THE INVENTION

The present invention has been made in view of the foregoing situations, and an object of the present invention is to provide an image forming apparatus and an image forming method which can automatically switch between the normal mode for a general document and a special mode for a special document or which can switch between the modes with a simple operation.

In order to overcome the above-described problems, an image forming apparatus according to the present invention includes a reading unit, a document-type determining unit, a read-processing unit, an image-processing unit, and a control unit. The reading unit reads a document and converts the document into image data. The document-type determining unit distinguishes between a general document and a special document in accordance with the image data read by the reading unit. The read-processing unit performs read processing on the general document in a normal read-processing mode and performs read processing on the special document in a special read-processing mode. Function of the read processing in the normal read-processing mode and function of the read processing in the special read-processing mode are different from each other. The image-processing unit performs image processing on the general document in a normal image-processing mode and performs image processing on the special document in a special image-processing mode. Function of the image processing in the normal image-processing mode and function of the image processing in the special image-processing mode are different from each other. When the document determined by the document-type determining unit is the special document, the control unit sets the read-processing unit to the special read-processing mode and sets the image-processing unit to the special image-processing mode. When the document determined by the document-type determining unit is the general document, the control unit sets the read-processing unit to the normal read-processing mode and sets the image-processing unit to the normal image-processing mode.

An image forming method according to the present invention includes a step of reading a document and converting the document into image data, a step of distinguishing between a general document and a special document in accordance with the image data read by the reading unit, and a step of performing read processing on the general document in a normal read-processing mode and performing read processing on the special document in a special read-processing mode. The read processing in the normal read-processing mode and the read processing in the special read-processing mode are different from each other. The method further includes a step of performing image processing on the general document in a normal image-processing mode and performing image processing on the special document in a special image-processing mode. The image processing in the normal image-processing mode and the image processing in the special image-processing mode are different from each other. The method further includes a step of performing setting to the special read-processing mode and performing setting to the special image-processing mode, when the distinguished document is the special document, and performing setting to the normal read-processing mode and performing setting to the normal image-processing mode, when the distinguished document is the general document.

According to the image forming apparatus and the image forming method according to the present invention, the normal mode for processing a general document and a special mode for processing a special document can be switched with a simple operation or can be automatically switched.

### BRIEF DESCRIPTION OF THE DRAWINGS

FIG. 1 is a block diagram showing one example of the configuration of an image forming apparatus according to an embodiment of the present invention;

FIG. 2 is a view showing one example of a special document to be processed by the image forming apparatus according to the embodiment of the present invention; and

FIG. 3 is a flow chart showing one example of processing of the image forming apparatus according to the embodiment of the present invention.

### DESCRIPTION OF THE PREFERRED EMBODIMENT

An image forming apparatus and an image forming method according to an embodiment of the present invention will be described below with reference to the accompanying drawings.

1) Exemplary Configuration of Image Forming Apparatus of Embodiment

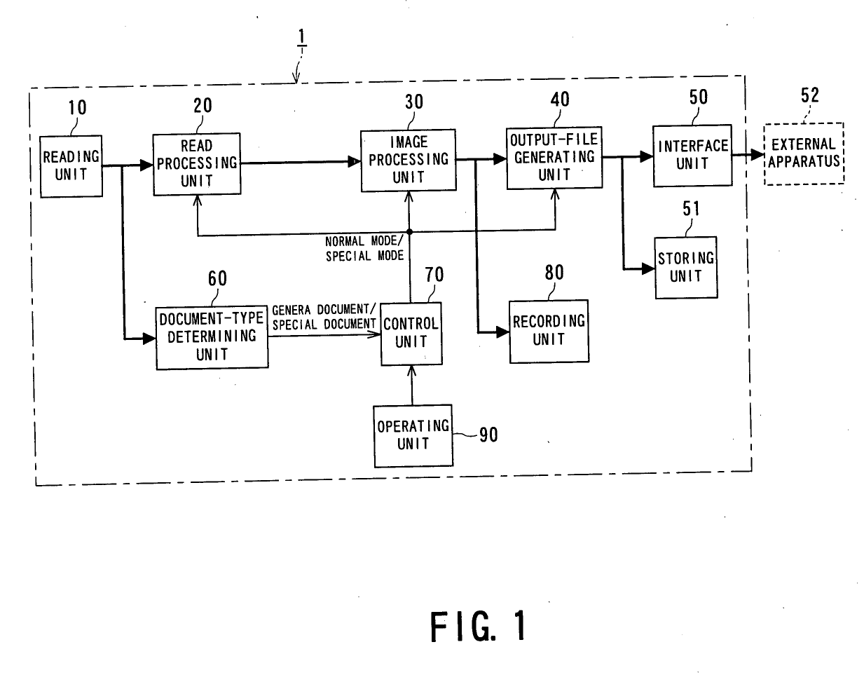

FIG. 1 shows an example of the configuration of an image forming apparatus 1 according to an embodiment of the present invention.

The image forming apparatus 1 includes a reading unit 10, a document-type determining unit 60, a read-processing unit 20, an image-processing unit 30, and an output-file generating unit 40. The reading unit 10 reads a document and converts the document into image data. The document-type determining unit 60 distinguishes between a general document and a special document in accordance with the image data read by the reading unit 10. The read-processing unit 20 performs read processing on the general document in a normal read-processing mode and performs read processing on the special document in a special read-processing mode, function of the read processing in the normal read-processing mode and in the special read-processing mode being different from each other. The image-processing unit 30 performs image processing on the general document in a typical image-processing mode and performs image processing on the special document in a special image-processing mode, function of the image processing in the normal image-processing mode and in the special image-processing mode being different from each other. In accordance with the image data processed by the image-processing unit 30, the output-file generating unit 40 generates an electronic file to be output to outside.

The image forming apparatus 1 further includes a control unit 70. When the document determined by the document-type determining unit 60 is a special document, the control unit 70 sets the read-processing unit 20 to the special read-processing mode and sets the image-processing unit 30 to the special image-processing mode. When the document determined by the document-type determining unit 60 is a general document, the control unit 70 sets the read-processing unit 20 to the normal read-processing mode and sets the image-processing unit 30 to the normal image-processing mode.

In addition, the image forming apparatus 1 includes an interface unit 50, a storing unit 51, a recording unit 80, and an operating unit 90. The interface unit 50 communicates the electronic file, generated by the output-file generating unit 40, with an external apparatus 52. The storing unit 51 stores the electronic file generated by the output-file generating unit 40. The recording unit 80 prints the image data generated by the image-processing unit 30. The operating unit 90 allows a user to perform various setting operations on the image forming apparatus 1.

The image forming apparatus 1 of the present embodiment is configured to be operable in two operation modes, i.e., a “normal mode” and a “special mode”.

The “normal mode” refers to a processing mode for a general document including characters and pictures. For example, the “normal mode” is a mode provided in a copy mode or a scan mode in an MFP apparatus and processed by switching the document mode. The image forming apparatus 1 is generally set to the “normal mode”, in which the image data of a read document is subjected to the normal read processing and normal image processing. Thereafter, the resulting image data is printed by the recording unit 80 or is converted into an electronic file in a standard format for communication with the external apparatus 52.

On the other hand, the “special mode” refers to a processing mode for a special document, such as a tax/finance-related document. When the image forming apparatus 1 is set to the “special mode”, the read-processing unit 20 is controlled so as to perform special read-processing suitable for reading a special document. The image-processing unit 30 is also controlled so as to perform special image-processing suitable for special-document image processing. Further, the output-file generating unit 40 can generate an electronic file in a special format corresponding to an electronic file for the special document.

The number of types of “special mode” is not necessarily limited to one. Thus, multiple different “special modes” may be provided depending on a difference in processing functions of the read processing and the image processing or depending on a combination of processing functions of the read processing and the image processing.

The reading unit 10 functions as a scanner. The reading unit 10 includes, for example, a light source for illuminating a document with light; a sensor for converting light reflected from the document into image data; an optical system for guiding and converging the light, reflected from the document, to the sensor; and a drive system for driving the light source in a sub-scanning direction.

The image data read by the reading unit 10 is output to the read-processing unit 20 and the document-type determining unit 60.

The read-processing unit 20 has a tone-characteristic conversion table for converting a tone characteristic of the document image data output from the sensor. The image forming apparatus 1 of the present embodiment has a plurality of tone-characteristic conversion tables. For example, a tone-characteristic conversion table for the “normal mode” and a tone-characteristic conversion table for the “special mode” are switched in accordance with a switching signal supplied from the control unit 70.

In the “normal mode”, when a general document is read for digitization, the read-processing unit 20 has a function for reading a document such that the underlying white color (i.e., the paper color) of the document does not stand out so as to prevent the underlying white color from being seen as stains.

Specifically, for example, the tone-characteristic conversion table selected in the “normal mode” is set to provide such a saturation characteristic that white color brighter than the underlying white color of the document does not exceed the brightness of the underlying white color. Further, during printing, the arrangement is such that the underlying white color of the document has substantially the same brightness as the white color of print paper. This processing (hereinafter referred to as “normal underlying-color processing”) prevents the underlying white color of the document from appearing on a print document, thus making it possible to create a clear print document.

On the other hand, the tone-characteristic conversion table selected in the “special mode” has such a tone characteristic that saturation does not occur even for color that is brighter than the underlying white color of the document. This makes it possible to read even high-brightness white, such as the color of a white-out, without saturation.

The image-processing unit 30 performs various types of image processing on the read image data. For example, based on RGB signals output from the sensor, the image-processing unit 30 converts the image data into data having a CMYK density. This density conversion (which may also be referred to as “color conversion”) is also processing involving tone conversion and is performed based on, for example, a density-tone conversion table.

The image-processing unit 30 of the present embodiment has multiple density-tone conversion tables for the “normal mode” and the “special mode”. For example, by selectively switching the density-tone conversion tables in accordance with a switching signal from the control unit 70, the image-processing unit 30 can provide a density-tone conversion characteristic suitable for each mode.

The image-processing unit 30 may be configured so as to perform image processing for switching the settings of the underlying-color density of a document between the “normal mode” and the “special mode”. Since an increased density of the underlying color causes it look like stains in the “normal mode”, the density of the underlying color is set to be closer to the underlying white color of print paper. In contrast, in the “special mode”, the underlying color of the document is set to be slightly darker than that in the “normal mode” so as to allow a corrected spot of the white-out or the like to stand out.

The image-processing unit 30 has a smoothing filter for smoothing pictorial images and an enhancing filter for enhancing characters. The image-processing unit 30 may have a function for automatically identifying a document mode, i.e., a function for automatically identifying whether pixels of a document to be processed are in a character area or in a picture area and automatically switching filter characteristics in accordance with the result of the identification of the pixels.

General documents often contain both characters and pictures on the same page. Thus, when the image forming apparatus 1 is set to the “normal mode”, the function for automatically identifying the document mode is activated to automatically switch the filter characteristics in accordance with an identified character area or picture area.

On the other hand, special documents, such as tax/finance-related documents, contain only characters in many cases, and the significance of character information is thus high compared to general documents. The necessity of accurately reading even small characters is also high. Thus, in the “special mode”, character-oriented processing is much more required than the “normal mode”.

Specifically, for example, when the “special mode” is selected, the function for automatically identifying the document mode is disabled and filter processing for enhancing characters is forcibly selected. The character enhancing filter may take a form of more enhancing characters than the filter used in the “normal mode”.

The output-file generating unit 40 generates a file to be stored in the storing unit 51 or an electronic file to be transferred to the external apparatus 52 via the interface unit 50. In this case, the output-file generating unit 40 is configured such that it can appropriately select and change the format of an electronic file depending on whether the image forming unit 1 is in the “normal mode” or the “special mode”.

For example, in the “normal mode”, a typical image file format, such as JPEG or TIFF, is selected.

In order to digitize a special document such as a tax/finance-related document and to certify it as an electronic master copy, special electronic information, such as a certification and a time stamp (year/month/date/time information at the time of digitization) issued by a third party, may be embedded. Thus, the read special document may be stored in a special file format that is different from the format in the “normal mode” or a special interface that is different from the interface used in the “normal mode” may be used to communicate with the external apparatus 52.

In some cases, it is preferable that the image compression rate be set to a specific compression rate suitable for a corresponding electronic file without being restricted to the compression rate for the typical file format, such as JPEG or TIFF.

Thus, when the “special mode” is selected, the output-file generating unit 40 generates an electronic file in a special file format. Also, the output-file generating unit 40 may be configured such that, it can select a specific compression rate instead of the image compression rate for the “normal mode”, when the “special mode” is selected.

As described above, since the image forming apparatus 1 has the “special mode”, which is different from the “normal mode”, it can perform image processing for reading a special document, such as a tax/finance-related document, or processing specialized for generating an electronic file of the special document.

On the other hand, in the image forming apparatus 1 having the “normal mode” and the “special mode”, each of the read processing unit 20, the image-processing unit 30, and the output-file generating unit 40 needs to select multiple types of processing which correspond to the respective modes. That is, each processing unit, such as the image-processing unit 30, has multiple sub-modes so as to correspond to the main modes, i.e., “normal mode” and the “special mode”, thereby increasing the complexity.

Consequently, when the selection of individual processing functions (sub-modes) and the setting of parameters (such as a filter coefficient) in the sub-modes during the switching between the “normal mode” and the “special mode” are left to a user, the operational burden on the user is considerably increased. The risk of operation mistake is also increased.

In the image forming apparatus 1 of the embodiment of the present invention, a combination of sub-modes for the main modes, i.e., the “normal mode” and the “special mode”, and parameters in the individual sub-modes are predetermined. When the “special mode” is selected, parameters and a combination of corresponding sub-modes are automatically selected.

2) Switching Between Normal Mode and Special Mode

The switching between the “normal mode” and the “special mode” can be achieved by a manual system or an automatic system.

In the automatic system, the provision of an appropriate change-over switch at the operating unit 90 allows the user to easily select between the “normal mode” and the “special mode”. The operating unit 90 has, for example, a liquid crystal display unit and a control panel having a touch panel covering the liquid crystal display unit. On the touch panel, the user depresses the change-over switch displayed on the liquid crystal display unit to switch between the “normal mode” and the “special mode”.

The reading of special document, such as tax/finance-related documents, is not required in some cases, depending on a place where the image forming apparatus 1 is installed. When the switching to the “special mode” is unnecessary as in such a case, the arrangement may be such that the display of the change-over switch on the liquid crystal display unit is disabled (i.e., the change-over switch is not displayed).

The image forming apparatus 1 according to the present embodiment can switch between the “normal mode” and the “special mode” by the automatic system.

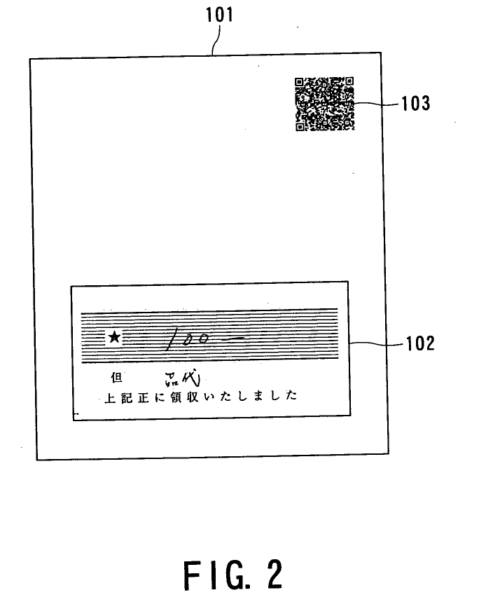

As illustrated in FIG. 2, an identification-information record 103 is pre-attached to a special document 102 such as a tax/finance-related document, for example, to a receipt. The reading unit 10 reads the identification-information record 103 and the document-type determining unit 60 identifies the identification-information record 103 to thereby determine whether or not the read document is a special document 101. When it is determined that the read document is a special document 101, the image forming apparatus 1 is automatically set to the “special mode”.

Although the form of the identification-information record 103 is not particularly limited, it may be achieved with a one-dimensional or two-dimensional barcode. In such a case, in addition to distinguishing between a general document and a special document, it is possible to identify a specific type and function of the special document. Consequently, the “special mode” can be further subdivided in accordance with the type and so on of a special document to achieve optimum processing corresponding to the document type and so on.

Tax/finance-related documents include many non-fixed-size forms, such as receipts. Thus, even when the special document is a non-fixed-size document, attaching the special document 102 to a fixed-size sheet 101, for example, an A4-size sheet, can improve the handling of the special document 102. The fixed-size sheet 101 may take a form that adsorbs the special document 102 or may take a form that is interposed between transparent double sheets.

Thus, attaching the non-fixed-size special document 102 to the fixed-size sheet 101 allows bulk reading using an ADF.

3) Registration and Change of Processing Function in Special Mode

When the image forming apparatus 1 is set to the “normal mode”, the types and ranges of parameters settable via the control panel (the operating unit 90) are limited to predetermined ranges. For example, restricting the adjustment range of an image density and the adjustment range of character sharpness to predetermined ranges can provide a normal image quality.

The image forming apparatus 1 may also be configured such that, when it is set to the “special mode”, the number of types and the ranges of parameters settable via the control panel can be increased compared to the “normal mode”. This arrangement makes it possible to set an image processing function and image processing parameters specialized for processing a specific special document.

The image forming apparatus 1 may also be configured to have a function for pre-registering a processing function for the set “special mode”. For example, when the special document is the type of “special document A”, types and a combination of read-processing and image-processing sub-modes that are most suitable for “special document A” or a file format used only for “special document A” are pre-registered. Similarly, when the special document is the type of “special document B”, types and a combination of read-processing and image-processing sub-modes that are most suitable for “special document B” or a file format used only for “special document B” may be pre-registered. In this case, when the type of document determined based on the identification-information record 103 attached to the special document is “special document A” or “special document B”, processing is performed based on the pre-registered types and combination of the read-processing and image-processing sub-modes or the pre-registered file format. The function of the registration can be appropriately changed using the control panel (the operating unit 90).

As described above, with the configuration in which the processing function in the “special mode” of the image forming apparatus 1 can be pre-registered and changed, the user can select optimum processing for a special document by simply switching the turn-over switch for the “normal mode” and the “special mode” in the case of the manual system. In the case of the automatic system, optimum processing for a special document can be selected by simply reading and determining the identification-information record 103 attached to the special document.

4) Example of Operation of Image Forming Apparatus 1

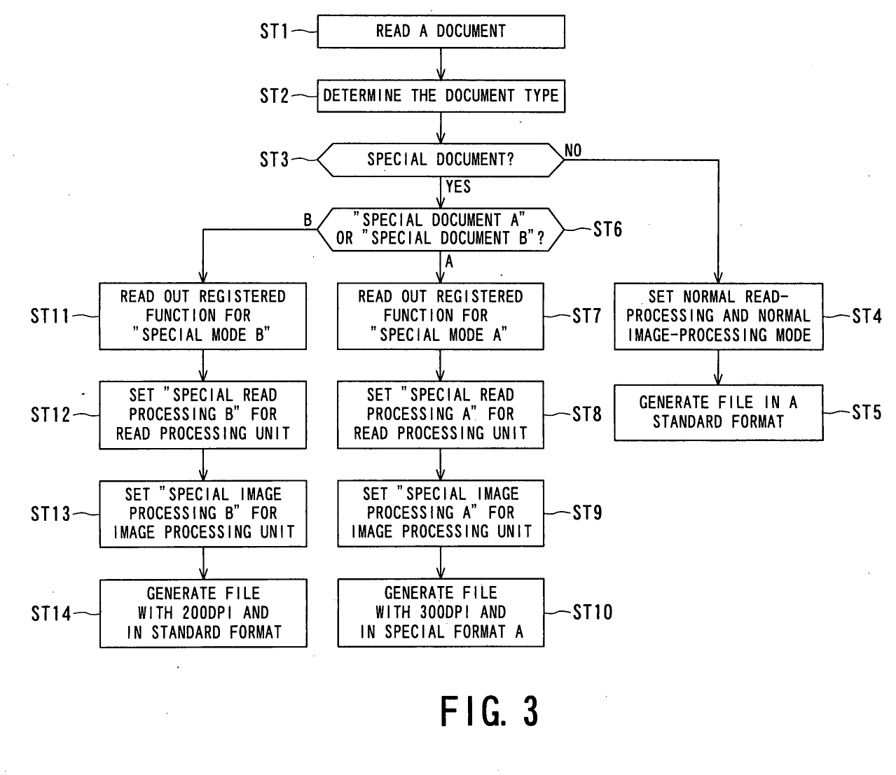

FIG. 3 is a flow chart showing one example of the operation of the image forming apparatus 1. More specifically, FIG. 3 shows an example in which the “normal mode” and the “special mode” are automatically determined.

The reading unit 10 reads a document placed by a user (in step ST 1).

Based on the read image data, the document-type determining unit 60 determines whether the document is a general document or a special document (in step ST2). This determination is made based on, for example, the presence/absence of the identification-information record 103 attached to the document.

When the identification-information record 103 is not present, it is determined that the read document is a general document (No in step ST3). As a result, the image forming apparatus 1 is set to the “normal mode”, so that the read-processing unit 20 is set to the normal read-processing mode to perform read processing and the image processing unit 30 is set to the normal image-processing mode to perform image processing (in step ST4). Further, the output-file generating unit 40 generates an electronic file in a standard format (in step ST5).

On the other hand, when the identification-information record 103 is attached, it is determined that the read document is a special document (Yes in step ST3).

In addition, in accordance with the content of the identification-information record 103, a determination is made as to whether the type of special document is “special document A” or “special document B” (in step ST6). Although a case in which two types of special documents are used is illustrated in FIG. 3, the number of types is not particularly limited to two.

When the type of special document is “special document A”, registered function of a special mode A, the function being optimally set for “special document A”, is read (in step ST7). Of processing contained in the special mode A, special read-processing A for read processing is set for the read-processing unit 20 (in step ST8). Similarly, of processing contained in the special mode A, special image-processing A for image processing is set for the image-processing unit 30 (in step ST9). Further, of processing contained in the special mode A, file-format-related information, such as a resolution “300 dpi” and a file format “special A”, is set for the output-file generating unit 40.

As a result, read processing and image processing corresponding to the special mode A are sequentially performed on “special document A”, so that an electronic file with the specified resolution “300 dpi” and in file format “special A” is generated (in step ST10).

When the type of special document is “special document B”, function of a special mode B is read (in step ST11). In the same manner described above, read processing and image processing corresponding to the special mode B are performed, so that an electronic file with the specified resolution “200 dpi” and in a standard file format (in steps ST12 to ST14) is generated.

The present invention is not only limited to the particular embodiment described above, and in practice, the elements described above can be modified and embodied without departing from the spirit and scope of the present invention. Some of the elements disclosed in the embodiment can be appropriately combined to achieve various modifications of the present invention. For example, some of the elements disclosed in the embodiment may be eliminated.

What is claimed is:

1. An image forming apparatus comprising:
a reading unit for reading a document and converting the document into image data;
a document-type determining unit for distinguishing between a general document and a special document in accordance with the image data read by the reading unit;
a read-processing unit for performing read processing on the general document in a normal read-processing mode and performing read processing on the special document in a special read-processing mode, a function of the read processing in the normal read-processing mode and a function of the read processing in the special read-processing mode being different from each other;
an image-processing unit for performing image processing on the general document in a normal image-processing mode and performing image processing on the special document in a special image-processing mode, a function of the image processing in the normal image-processing mode and a function of the image processing in the special image-processing mode being different from each other; and
a control unit for setting the read-processing unit to the special read-processing mode and setting the image-processing unit to the special image-processing mode, when the document determined by the document-type determining unit is the special document, and for setting the read-processing unit to the normal read-processing mode and setting the image-processing unit to the normal image-processing mode, when the document determined by the document-type determining unit is the general document.

2. The image forming apparatus according to claim 1, further comprising an output-file generating unit for generating an electronic file to be output, from image data processed by the image-processing unit, wherein the output-file generating unit generates electronic files in formats that are different from each other between when the document determined by the document-type determining unit is the special document and when the document determined by the document-type determining unit is the general document.

3. The image forming apparatus according to claim 1 or 2, wherein the document-type determining unit distinguishes between the general document and the special document in accordance with identification information attached to the special document.

4. The image forming apparatus according to claim 3, wherein the identification information comprises a barcode.

5. The image forming apparatus according to claim 1, further comprising an operating unit for displaying switching between a normal mode and a special mode and for performing mode setting by switching between the normal mode and the special mode, wherein, when the special mode is set, the control unit sets the read-processing unit to the special read-processing mode by priority and setting the image-processing unit to the special image-processing mode by priority, and when the normal mode is set, the control unit sets the read-processing unit to the normal read-processing mode by priority and sets the image-processing unit to the normal image-processing mode by priority.

6. The image forming apparatus according to claim 5, wherein the operating unit is capable of pre-disabling the setting of the special mode and the display of the switching to the special mode.

7. The image forming apparatus according to claim 5, wherein, when the special mode is set, the number of types and ranges of parameters settable via the control unit can be increased compared to a case in which the normal mode is set.

8. The image forming apparatus according to claim 1, further comprising an operating unit for pre-registering or changing at least one of read-processing functions of the read-processing unit in the special read-processing mode and the image-processing functions of the image processing unit in the special image-processing mode, wherein the control unit sets the read-processing function pre-registered or changed by the operating unit, for the read-processing unit and sets the image-processing function pre-registered or changed by the control unit, for the image-processing unit.

9. The image forming apparatus according to claim 2, further comprising an operating unit for pre-registering or changing a format of a file generated by the output-file generating unit, wherein the output-file generating unit generates a file in the file format pre-registered or changed by the operating unit.

10. An image forming method comprising the steps of:
reading a document and converting the document into image data;
distinguishing between a general document and a special document in accordance with the image data read by the reading unit;
performing read processing on the general document in a normal read-processing mode and performing read processing on the special document in a special read-processing mode, the read processing in the normal read-processing mode and the read processing in the special read-processing mode being different from each other;
performing image processing on the general document in a normal image-processing mode and performing image processing on the special document in a special image-processing mode, the image processing in the normal image-processing mode and the image processing in the special image-processing mode being different from each other; and
performing setting to the special read-processing mode and performing setting to the special image-processing mode, when the distinguished document is the special document, and performing setting to the normal read-processing mode and performing setting to the normal image-processing mode, when the distinguished document is the general document.

11. The image forming method according to claim 10, further comprising a step of generating an electronic file to be output, from image data processed in the image-processing performing step, wherein in the electronic-file generating step, electronic files in formats that are different from each other are generated between when the distinguished document is the special document and when the distinguished document is the general document.

12. The image forming method according to claim 10 or 11, wherein, in the step of distinguishing between the general document and the special document, the general document and the special document are distinguished from each other in accordance with identification information attached to the special document.

13. The image forming method according to claim 12, wherein the identification information comprises a barcode.

14. The image forming method according to claim 10, further comprising a step of displaying switching between a normal mode and a special mode and of performing mode setting by switching between the normal mode and the special mode, wherein, in the mode-setting step, the special read-processing mode is set by priority and the special image-processing mode is set by priority, when the special mode is set, and the normal read-processing mode is set by priority and the normal image-processing mode is set by priority, when the normal mode is set.

15. The image forming method according to claim 14, wherein the setting of the special mode and the display of the switching to the special mode can be pre-disabled.

16. The image forming method according to claim 14, wherein, when the special mode is set, the number of types and ranges of parameters settable via a control unit can be increased compared to a case in which the normal mode is set.

17. The image forming method according to claim 10, further comprising a step of pre-registering or changing at least one of read-processing functions in the special read-processing mode and image-processing functions in the special image-processing mode, wherein, in the mode-setting step, the pre-registered or changed read-processing function is set and the pre-registered or changed image-processing function is set.

18. The image forming method according to claim 11, further comprising a step of pre-registering or changing a file format of the electronic file, wherein, in the electronic-file generating step, a file in the pre-registered or changed file format is generated.
